(19) United States
(12) Patent Application Publication
(10) Pub. No.: US 2026/0158569 A1
(43) Pub. Date: Jun. 11, 2026

(54) POWERED COPING SAW

(71) Applicant: Black & Decker Inc., New Britain, CT (US)

(72) Inventors: Joseph Patrick Kelleher, Parkville, MD (US); Robert J. Cirincione, II, Towson, MD (US)

(21) Appl. No.: 19/416,952

(22) Filed: Dec. 11, 2025

Related U.S. Application Data
(60) Provisional application No. 63/730,629, filed on Dec. 11, 2024.

(51) Int. Cl. B23D 61/12; B23D 51/16

(52) U.S. Cl. CPC B23D 61/123; B23D 51/16

(57) ABSTRACT

A coping saw includes a handle, a saw blade, and a frame attached to the handle and configured to support the saw blade between two arms of the frame. The coping saw further includes an actuator attached to the handle, which is configured to apply reciprocating motion to the saw blade. A spring-loaded clamp may be connected to the frame to maintain tension on the saw blade during operation. In some configurations, the frame may include a pivoting linkage assembly to support the saw blade.

### CROSS REFERENCE TO RELATED APPLICATION

This application claims the benefit of U.S. Provisional Application No. 63/730,629, filed on Dec. 11, 2024, and titled “Powered Coping Saw”, which is incorporated by reference in its entirety.

### TECHNICAL FIELD

The present disclosure relates generally to power tools, such as powered saws and, more particularly, to powered saws for making precision cuts.

### BACKGROUND

Coping saws are tools specifically designed for making precise cuts, especially for fitting trim and molding at corners. Manual coping saws, while effective, can be labor-intensive, time-consuming, and require a high skill level, often leading to inconsistencies and physical strain. Powered alternatives, including jigsaws or grinders often lack the precision needed for accurate cuts.

### SUMMARY

In some implementations, a coping saw includes a handle; a saw blade; a frame attached to the handle and configured to support the saw blade between two arms of the frame; an actuator attached to the handle and configured to apply reciprocating motion to the saw blade; and a spring-loaded clamp connected to the frame and configured to maintain tension on the saw blade during operation.

In some implementations, the actuator comprises an electric motor and a reciprocating mechanism, and wherein the reciprocating mechanism is configured to convert rotational motion of the electric motor into the reciprocating motion.

In some implementations, the reciprocating mechanism is an eccentric cam.

In some implementations, the reciprocating mechanism is a slider and crank mechanism.

In some implementations, the reciprocating mechanism is a Scotch yoke mechanism.

In some implementations, the rotational motion comprises rotational motion around an axis that is generally perpendicular to an axis along which the saw blade travels during the reciprocating motion.

In some implementations, the rotational motion comprises rotational motion around an axis that is generally parallel to an axis along which the saw blade travels during the reciprocating motion, and wherein the actuator further comprises a bevel gear set configured to transfer the rotational motion to the reciprocating mechanism.

In some implementations, the actuator is a linear solenoid.

In some implementations, the spring-loaded clamp is connected to the frame via a linear bearing assembly.

In some implementations, the frame is a U-shaped frame, and the frame is attached to the handle via one arm of two substantially parallel arms of the frame.

In some implementations, the frame comprises an L-shaped fixed frame portion and a U-shaped linkage assembly, wherein the frame is attached to the handle via the L-shaped fixed

frame portion, and wherein the U-shaped linkage assembly includes the two substantially parallel arms.

In some implementations, the U-shaped linkage assembly comprises six pivot points, is pivotably attached to the L-shaped fixed frame portion at a first pair of the pivot points and is pivotably attached to the saw blade at a second pair of the pivot points.

In some implementations, the two substantially parallel arms are configured to pivot about the first pair of pivot points.

In some implementations, the coping saw includes a variable speed trigger operably connected to the actuator for controlling the reciprocating motion of the saw blade.

In some implementations, the coping saw includes a stabilizing shoe attached to the handle.

In some implementations, the coping saw includes a battery pack attached to a first end of the handle, wherein the actuator is attached to a second end of the handle opposite the first end.

In some implementations, the saw blade includes a forward biased tooth configuration.

In some implementations, the saw blade includes a neutrally biased tooth configuration.

In some implementations, a coping saw includes a handle; a saw blade; a linkage assembly attached to the handle and configured to support the saw blade between two substantially parallel arms of the linkage assembly, wherein the two substantially parallel arms are pivotably attached to a fixed frame portion of the linkage assembly at a first pair of pivot points; and an actuator attached to the handle and configured to apply reciprocating motion to the saw blade.

In some implementations, the fixed frame portion is L-shaped, wherein a U-shaped linkage portion of the linkage assembly includes the two substantially parallel arms, and wherein the linkage assembly is attached to the handle via the fixed frame portion.

In some implementations, the linkage assembly is pivotably attached to the saw blade at a second pair of pivot points.

In some implementations, the U-shaped linkage portion comprises an offset arm pivotably attached to the two substantially parallel arms at a third pair of pivot points.

In some implementations, the device includes a spring-loaded clamp connected to the linkage assembly and configured to maintain tension on the saw blade during operation.

In some implementations, a coping saw includes a handle; a saw blade; a frame attached to the handle and configured to support the saw blade between two arms of the frame; and a linear solenoid attached to the handle and configured to apply reciprocating motion to the saw blade.

In some implementations, the coping saw includes a variable speed trigger operably connected to the linear solenoid for controlling the reciprocating motion of the saw blade.

In some implementations, the coping saw includes a battery pack removably attached to a first end of the handle, wherein the linear solenoid is attached to a second end of the handle opposite the first end.

### BRIEF DESCRIPTION OF THE DRAWINGS

FIG. 1 is a diagram of an example implementation of a powered coping saw.

FIG. 2 is a diagram of another example implementation of a powered coping saw.

FIGS. 3A and 3B are diagrams of the example powered coping saw of FIG. 2 illustrating operation of the coping saw.

FIG. 4 is a diagram of another example implementation of a powered coping saw that includes a linkage assembly.

FIGS. 5A and 5B are diagrams of the example powered coping saw of FIG. 4 illustrating operation of the coping saw.

### DETAILED DESCRIPTION

The following detailed description of example implementations refers to the accompanying drawings. The same reference numbers in different drawings may identify the same or similar elements.

Coping saws are cutting tools designed for making precise cuts, particularly when fitting trim and molding at corners, a technique known as coping. While hand coping saws can be effective, their manual operation can be labor-intensive and time-consuming, especially when working with harder materials or intricate profiles. This manual process requires significant skill and can lead to inconsistencies in the quality of the finish, as well as physical strain on the user. Powered alternatives, including jigsaws with specialized coping feet or grinders, often lack precision and stability and may lead to imprecise cuts.

Some implementations described herein provide a powered coping saw designed to improve the efficiency and precision of coping tasks. The coping saw may include a handle, a saw blade, a frame attached to the handle configured to support the saw blade between two arms of the frame, and an actuator attached to the handle configured to apply reciprocating motion to the saw blade. The reciprocating motion may be linear or orbital. In some instances, the actuator may be an electric motor connected to a reciprocating mechanism, such as an eccentric cam, slider and crank, or a Scotch yoke mechanism, capable of converting rotational motion of the electric motor into reciprocating motion. Alternatively, the coping saw may be driven by a linear solenoid.

A spring-loaded clamp may be connected to the frame and configured to maintain tension on the saw blade during operation. In some instances, a variable speed trigger may be operably connected to the actuator allowing for controlling the motion of the saw blade, and a battery may be attached to the handle to power the device.

Some aspects of the powered coping saw described herein may provide enhanced operational efficiency through the automation of the reciprocating motion of the saw blade. The compact design allows for precise control of the saw blade's position, while the actuator enables consistent cutting speed, which may lead to more accurate cuts. The spring-loaded clamp ensures saw blade tension, which contributes to the accuracy of the cuts and may extend the lifespan of the saw blade by preventing slippage and breakage. In some instances, the coping saw may be compatible with a standard coping saw blade, reducing the need for specialized components. In implementations that incorporate a variable speed trigger, the coping saw provides a level of control over the cutting speed, allowing for adjustments to suit different materials and coping profiles. The ability to power the device with a battery enhances the coping saw's portability and convenience. In some instances, the components of the coping saw, such as the motor or solenoid and battery, may be arranged to distribute weight in a manner designed to place the center of gravity at or near the wrist of the user, further improving control over the coping saw. In this way, the powered coping saw may provide a variety of benefits for precision cutting.

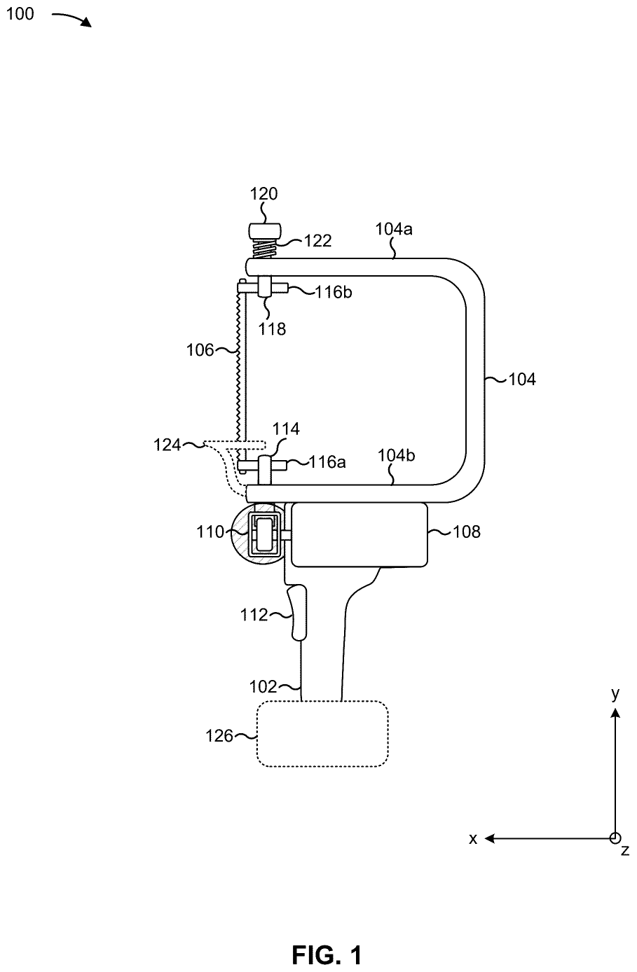

FIG. 1 is a diagram of an example implementation of a powered coping saw 100. As shown in FIG. 1, the coping saw 100 may comprise a handle 102, a frame 104, a saw blade 106, and an actuator 108, among other components. These components are described in further detail herein.

As shown in FIG. 1, the handle 102 may provide a secure and stable grip for a user of the coping saw 100. The handle 102 may be constructed from any of a variety of materials, including polymers and/or composites, such as fiberglass-reinforced nylon, which are designed to have high strength and durability. In some instances, the handle 102 may be hollow and/or include space for components such as electronic control modules, electrical wiring, batteries, and/or the like.

As shown in FIG. 1, the frame 104 may be configured to support the saw blade 106 between two arms 104a, 104b of the frame 104. For example, the frame 104 may be U-shaped, C-shaped, or otherwise shaped to enable opposing arms 104a and 104b to support the saw blade 106 in between. In some examples, the arms 104a and 104b may be substantially parallel to one another. In some instances, the frame 104 may provide stability and tension for the saw blade 106 while also providing space for the coping saw 100 to make deep cuts. For example, the frame 104 may provide tension in instances where the frame 104 is elastic enough to enable the frame to be compressed for attaching the saw blade 106, such that decompression of the frame 104 provides tension to pull the attached saw blade 106 taut between opposing arms 104a and 104b of the frame 104. In some instances, the frame 104 may be rigid, and tension for the saw blade 106 may be provided by other means. The frame 104 may be constructed from any of a variety of durable materials, such as high-strength steel, aluminum, or reinforced polymers, to ensure rigidity, elasticity, and/or longevity while maintaining a lightweight design. In some instances, the frame 104 is attached to the handle 102 via one arm 104b of the two substantially parallel arms 104a, 104b. For example, the arm 104b closest to the handle 102 may be attached to the handle 102 via a fastening mechanism, such as screws, bolts, and/or an adhesive.

In some instances, the saw blade 106 may include pins or holes at either end to facilitate attaching the saw blade 106 to the coping saw 100. The saw blade 106 is designed to be removable, e.g., to facilitate replacement, cleaning, and/or the like. In some instances, the saw blade 106 may be rotatable around an axis along which the saw blade 106 reciprocates. For example, the saw blade 106 may rotate around a y-axis depicted for the example coping saw 100, which may enable the coping saw 100 to be used for making cuts at various angles.

In some instances, the saw blade 106 may include a forward biased tooth configuration. For example, a forward biased tooth configuration may include a configuration where the teeth of the saw blade 106 are angled toward an end of the coping saw 100 opposite the handle 102. In some instances, the saw blade 106 may include a neutrally biased tooth configuration where the teeth of the saw blade 106 are straight (e.g., substantially perpendicular to the axis along which the saw blade 106 reciprocates), rather than angled toward or away from the end of the coping saw 100. The different teeth configurations of the saw blade 106 provide versatility to the coping saw 100, enabling the coping saw 100 to be used in a variety of situations and for a variety of different cutting styles.

As depicted in FIG. 1, the actuator 108 may be attached to the handle 102. The actuator 108 may be configured to apply reciprocating motion to the saw blade 106. The reciprocating motion may be linear or orbital. In some instances, the actuator 108 may include an electric motor and a reciprocating mechanism 110, which converts the rotational motion of the electric motor into reciprocating motion. For example, the actuator may be aligned parallel to an x-axis depicted for the example coping saw 100, and the electric motor may be configured to apply rotational force around the x-axis. The reciprocating mechanism 110 may be configured to transfer the rotational force around the x-axis into reciprocating motion along the y-axis. For example, the reciprocating mechanism 110 may provide reciprocating motion to a driving member 114, which is attached to the saw blade 106 (e.g., via a blade attachment member 116a) and configured to transfer the reciprocating motion to the saw blade 106.

In some instances, the reciprocating mechanism 110 may include an eccentric cam. For example, an eccentric cam achieves reciprocating motion by having an off-center cam that translates rotational motion into reciprocating motion through the displacement of the cam profile.

In some instances, the reciprocating mechanism 110 may include a slider and crank mechanism. For example, in a slider and crank mechanism, a rotating crank converts the rotational motion of an electric motor into reciprocating motion via a connecting rod that slides within a guide, providing the reciprocating motion as output.

In some instances, the reciprocating mechanism 110 may include a Scotch yoke mechanism. For example, a Scotch yoke mechanism translates the rotational motion of the electric motor into reciprocating motion through a yoke that slides back and forth on a guide, driven by a pin attached to a rotating disk, or a crank.

In some instances, the rotational motion of the electric motor may occur around an axis (e.g., around the x-axis) that is perpendicular to the axis along which the saw blade 106 generally travels during the reciprocating motion (e.g., along the y-axis). Such an arrangement may enable the actuator 108 to be located near the frame 104 of the coping saw 100, which may provide better balance and control over the coping saw 100 relative to other placements of the actuator 108.

In some instances, the rotational motion of the actuator 108 (e.g., of the electric motor) may occur around one axis (e.g., the y-axis or the z-axis), and the actuator 108 may further include a bevel gear set for transferring the rotational motion from around the one axis (e.g., the y-axis or the z-axis) to around another axis (e.g., the x-axis) before transferring the rotational motion to the reciprocating mechanism 110. This may provide additional flexibility in the arrangement of the actuator 108 and the components of the actuator 108. For example, the actuator 108 may be arranged to provide rotational motion around the y-axis, which is parallel to the axis along which the saw blade 106 travels during reciprocating motion. In this example, a bevel gear set may be configured to transfer the rotational motion from around the y-axis to around another axis (e.g., the x-axis) before interacting with the reciprocating mechanism 110.

In some instances, the coping saw 100 may include a spring-loaded clamp 120 connected to the frame 104. The spring-loaded clamp 120 is configured to maintain tension on the saw blade 106. In particular, the spring-loaded clamp 120 is configured to maintain tension on the saw blade 106 during operation of the coping saw 100 (e.g., while the reciprocating motion is applied to the saw blade 106). For example, opposite ends of the saw blade 106 may be attached to the blade attachment members 116a and 116b, and a clamp portion 118 of the spring-loaded clamp 120 may be connected to the blade attachment member 116b while a spring 122 provides tension, causing the blade to be pulled taut between the blade attachment members 116a and 116b. In some instances, the spring-loaded clamp 120 includes a linear bearing assembly (e.g., not depicted but within or attached to the frame 104) configured to enable the spring-loaded clamp 120 to linearly slide along the same axis (e.g., along the y axis) as the saw blade 106 during operation. The linear bearing assembly may also be configured to provide stability during operation of the coping saw 100, e.g., by limiting the movement of the saw blade 106 to the reciprocating motion along the y-axis.

In some instances, the spring-loaded clamp 120 may be configured to enable adjustment of the tension of the saw blade 106. For example, the spring-loaded clamp 120 may include an adjustable fastening portion, such as a threaded screw portion, multi-slotted clevis pin, and/or the like, to provide tension for the saw blade 106. In this example, the adjustable fastening portion may enable the clamp portion 118 and/or blade attachment member 116b to be adjusted along the y-axis, enabling adjustment of the tension on the saw blade 106. In some instances, the adjustable fastening portion used for providing tension may also be used for the attachment and detachment of the saw blade 106 to the blade attachment member 116b. Additionally, or alternatively, the driving member 114 may be configured to enable adjustment of the tension on the saw blade 106 by adjusting the blade attachment member 116b relative to the driving member 114 in a manner similar to that described above (e.g., using an adjustable fastening portion).

In some instances, the blade attachment members 116a and 116b may be rotatably attached to the clamp portion 118 on one end of the saw blade 106 and the driving member 114 of the reciprocating mechanism 110 on the other end of the saw blade 106. The blade attachment members 116a and 116b may be rotated about the clamp portion 118 and/or the driving member 114 to impart an angle on the saw blade 106 for angled cuts. For example, the blade attachment members 116a and 116b may use one or more fasteners, such as threaded fasteners, to secure the saw blade 106 and/or secure the blade attachment members 116a and 116b to the clamp portion 118 and/or the driving member 114. Additionally, or alternatively, the blade attachment members 116a and 116b may be removably attached to the saw blade 106, enabling the saw blade 106 to be detached, e.g., for maintenance and/or replacement.

In some instances, the coping saw 100 may comprise a variable speed trigger 112 operably connected to the actuator 108 for controlling the motion of the saw blade 106. In some instances, other types of control mechanisms, such as a rotary dial, push-button controls, on/off switches, and/or selectable speed controls, may be used to activate and/or control the speed of the actuator 108.

In some instances, a removable, rechargeable battery pack 126 may be attached to a first end of the handle 102, while the actuator 108 is attached to the opposite end of the handle 102. The example battery pack 126 may have nominal voltage of 12V, 18V, 20V, and/or 24V, which may offer varying degrees of power and runtime. In some instances, rather than an externally attached battery pack 126, the handle 102 may be hollow and may include a cavity and connections for an internal integrated battery pack 126 or batteries to be inserted within the handle 102. The battery pack 126 may be designed to provide balance and stability for an operator of the coping saw 100. For example, arranging the various components of the coping saw 100 such that a center of gravity is at a point in the handle 102 at or near an expected location of an operator's wrist may provide additional stability and comfort during operation of the coping saw 100. Additionally, or alternatively, the coping saw 100 may be corded to provide a constant source of power.

In some instances, the coping saw 100 may further include a stabilizing shoe 124. The stabilizing shoe 124 may be removably attached to the frame 104 or the handle 102. For example, the stabilizing shoe 124 may provide additional support and stability during operation of the coping saw (e.g., during application of the reciprocating motion to the saw blade 106), allowing for more precise and controlled cutting.

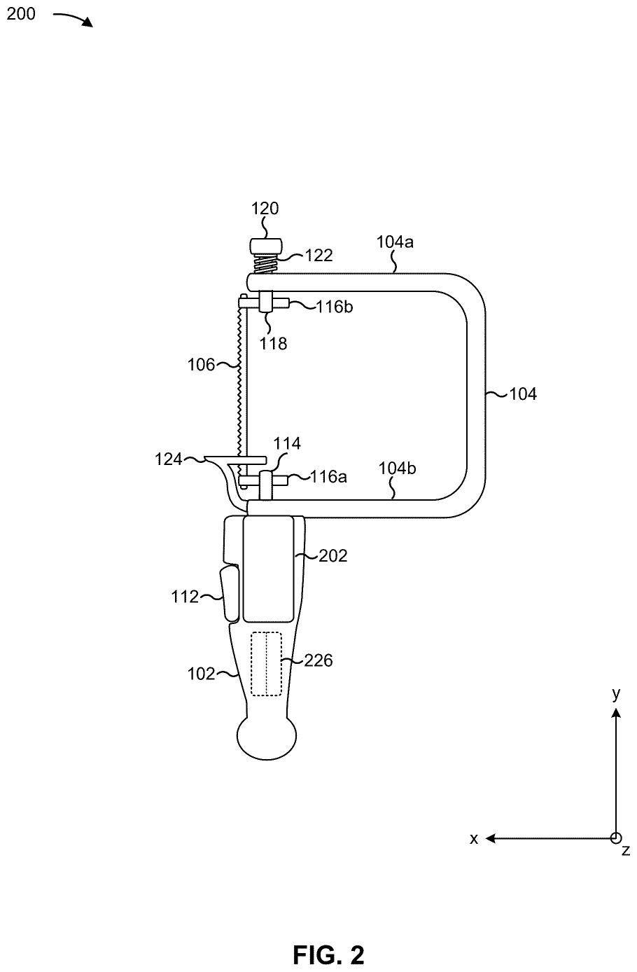

FIG. 2 is a diagram of another example implementation of a powered coping saw 200. As shown in FIG. 2, the example coping saw 200 may comprise a handle 102, a frame 104, and a saw blade 106, among other components.

In some instances, as shown in the example coping saw 200, a linear solenoid 202 may be the actuator that provides reciprocating motion to the saw blade 106. For example, the linear solenoid 202 may convert electrical energy into reciprocating motion directly, providing a straightforward and efficient means to drive the saw blade 106. In some instances, the linear solenoid 202 may be arranged such that the reciprocating motion is applied directly to the driving member 114. By using a linear solenoid 202, the coping saw 200 may enable an efficient cutting motion while limiting the number of moving parts, e.g., relative to other means for applying reciprocating motion to the saw blade 106.

The different types of actuators may, in some situations, provide different rates of reciprocation for the saw blade 106. For example, an electric motor may enable up to 6,000 revolutions per minute (e.g., 100 cycles per second). Example linear solenoids may enable reciprocation in a range, for example, up to 60 cycles per second. As described herein, a variable speed trigger 112 or similar mechanism may enable operation of the coping saw 200 at different frequencies (e.g., cycles per minute or per second). Additionally, or alternatively, the amplitude of reciprocation may be adjustable, such that the length of each stroke of the saw blade 106 may be fixed at certain distances, providing additional control over the coping saw 200.

The example coping saw 200 may also include a battery compartment 226 within the handle 102. The battery compartment 226 may accommodate one or more batteries to provide

power for the coping saw 200. As described herein, the batteries may add weight to the handle when accommodated within the battery compartment 226, providing additional stability, consistency, and balance during operation, while also enabling free movement by the operator without the need for a cord.

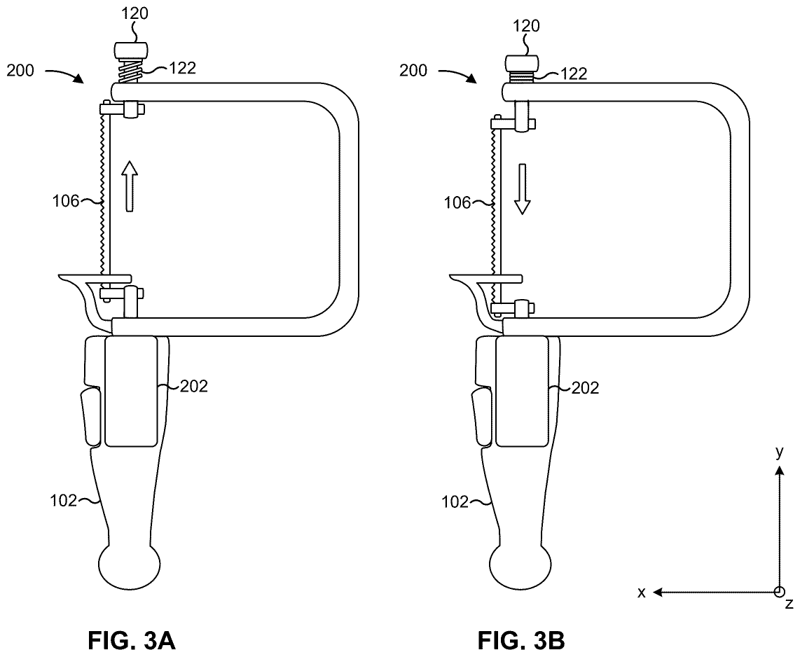

FIGS. 3A and 3B illustrate an example operation of the powered coping saw of FIG. 2. As shown in FIGS. 3A and 3B, during operation, the saw blade 106 moves generally along the y-axis, driven by the linear solenoid 202, which may be functioning as the actuator. When the saw blade 106 is moving away from the handle 102, as shown in FIG. 3A, the spring-loaded clamp 120 extends away from the handle 102 along the y-axis. When the saw blade 106 is moving toward the handle 102, as shown in FIG. 3B, the spring-loaded clamp 120 compresses toward the handle 102 along the y-axis. In this way, the saw blade 106 of the coping saw 200 reciprocates with the assistance of the spring-loaded clamp 120, and the spring-loaded clamp 120 maintains tension on the saw blade 106 while the saw blade 106 is reciprocating.

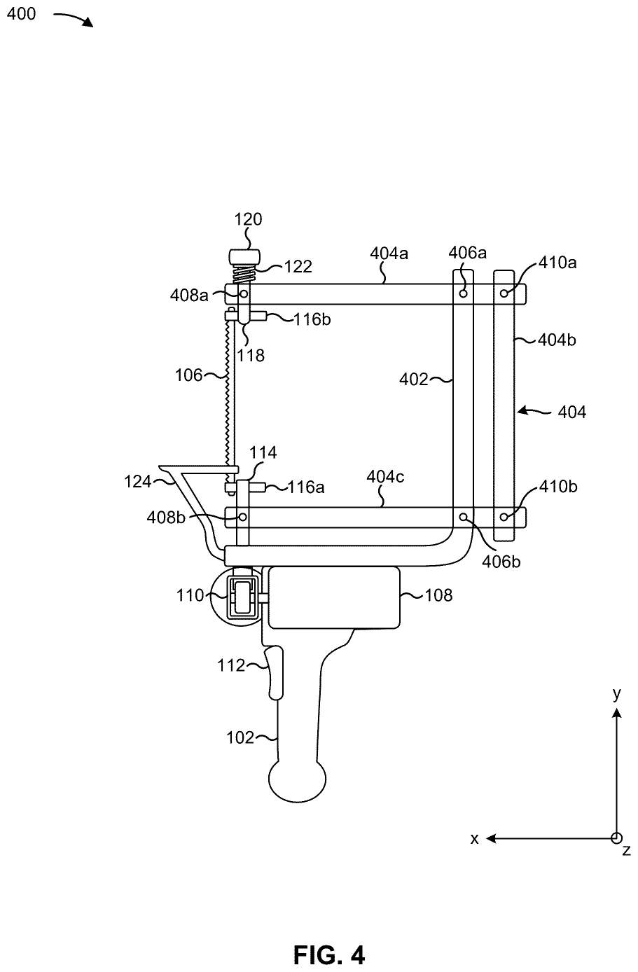

FIG. 4 is a diagram of an example implementation of a powered coping saw 400 that may include a linkage assembly 404. As shown in FIG. 4, the coping saw 400 may include a handle 102, a saw blade 106, an actuator 108, and a linkage assembly 404, among other components.

In some instances, the linkage assembly 404 may support the saw blade 106 between two substantially parallel arms 404a and 404c. In this configuration, the two substantially parallel arms 404a and 404c may be pivotably attached to a fixed frame portion 402 of the linkage assembly 404 at a first pair of pivot points 406a, 406b.

As shown in the example coping saw 400, the fixed frame portion 402 may have an L-shape and attached to the handle 102, providing structural support for the linkage assembly 404. A U-shaped linkage portion of the linkage assembly 404 may include the two substantially parallel arms 404a and 404c, along with an offset arm 404b. The two substantially parallel arms 404a and 404c are attached to the saw blade 106 via the driving member 114, the clamp portion 118 of the spring-loaded clamp 120, and the blade attachment members 116a and 116b.

As shown in the example coping saw 400, the linkage assembly 404 is pivotably attached to the saw blade 106 at a second pair of pivot points 408a, 408b. For example, the two substantially parallel arms 404a and 404c of the U-shaped linkage portion may be pivotably attached to the saw blade 106 (e.g., via the clamp portion 118 and the driving member 144, respectively) at the second pair of pivot points 408a, 408b. The offset arm 404b is pivotably attached to the two substantially parallel arms 404a and 404c at a third pair of pivot points 410a, 410b, maintaining the parallel alignment and stability of the two substantially parallel arms 404a, 404c and the saw blade 106 during operation.

In some instances, the linkage assembly 404 may be partially covered or completely enclosed in a protective enclosure. A protective enclosure may protect both the operator and the linkage assembly 404 during operation and prevent contaminants from causing damage to or otherwise degrading the performance of the pivot points 406 or other components of the linkage assembly 404.

As described herein, the coping saw 400 may include other components to facilitate the reciprocating motion of the saw blade 106 during operation. While a spring-loaded clamp 120 is included in the example coping saw 400, in some instances, the spring-loaded clamp 120 may be omitted in a coping saw 400 that includes a linkage assembly 404.

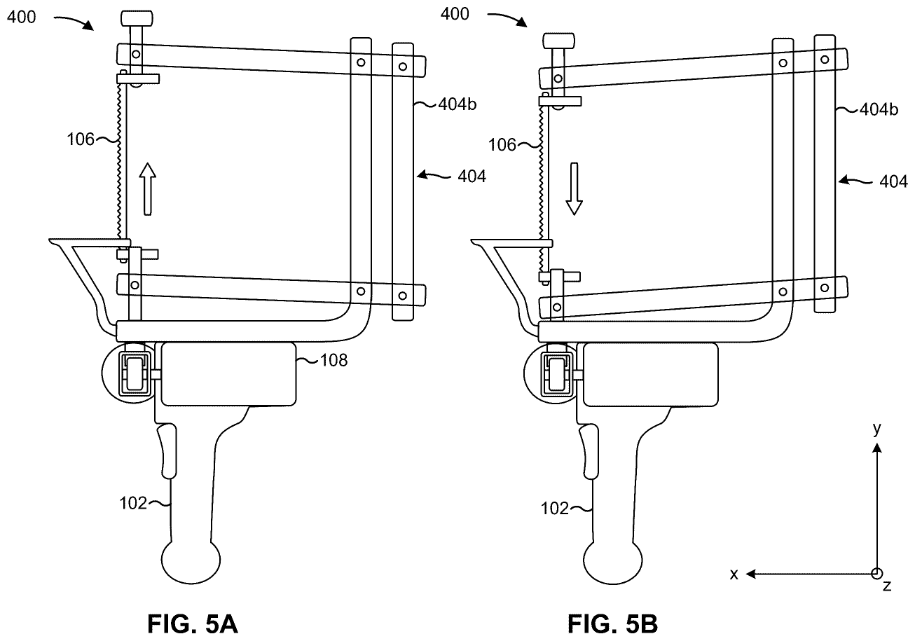

FIGS. 5A and 5B illustrate an example operation of the powered coping saw of FIG. 4. As shown in FIGS. 5A and 5B, during operation, the saw blade 106 moves generally along the y-axis,

driven by the actuator 108. When the saw blade 106 is moving away from the handle 102, as shown in FIG. 5A, the linkage assembly 404, and the offset arm 405b in particular, moves toward the handle 102 along the y-axis. When the saw blade 106 is moving toward the handle, as shown in FIG. 5B, the linkage assembly 404, and the offset arm 404b in particular, moves away from the handle 102 along the y-axis. In this way, the linkage assembly 404 provides stability and alignment for the saw blade 106 of the coping saw 400 during operation of the coping saw 400 (e.g., while the saw blade is reciprocating).

In some instances, to ensure that the coping saw can be effectively used in both powered and manual modes, a locking mechanism may be incorporated. For example, a spindle lock system may be employed that locks the driving member 114 in place when hand operation is desired. As another example, a locking pin system may be employed to secure the electric motor or linear solenoid in a fixed position, preventing any reciprocating motion from affecting the saw blade 106 during manual operation. In some instances, the spring-loaded clamp 120 may also be lockable in a fixed position, in a manner designed to ensure the saw blade 106 remains taut. This allows the coping saw to be versatile and functional in various scenarios.

As described herein, some aspects of the powered coping saw may provide enhanced operational efficiency through the automation of the reciprocating motion. In some examples, the various components provide stability and alignment of the saw blade, enable for precise control of the saw blade's position, and facilitate consistent cutting speed, which may lead to more accurate cuts. In this way, the powered coping saw may provide a variety of benefits for precision cutting.

The foregoing disclosure provides illustration and description, but is not intended to be exhaustive or to limit the implementations to the precise forms disclosed. Modifications may be made in light of the above disclosure or may be acquired from practice of the implementations.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example implementations.

The term “approximately” includes values within ten percent greater or less than the stated value. Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A powered coping saw, comprising:
a handle;
a saw blade;
a frame attached to the handle and configured to support the saw blade between two arms of the frame;
an actuator attached to the handle and configured to apply reciprocating motion to the saw blade; and
a spring-loaded clamp connected to the frame and configured to maintain tension on the saw blade during operation.

2. The powered coping saw of claim 1, wherein:
the actuator comprises an electric motor and a reciprocating mechanism; and
the reciprocating mechanism is configured to convert rotational motion of the electric motor into the reciprocating motion.

3. The powered coping saw of claim 2, wherein the reciprocating mechanism is an eccentric cam.

4. The powered coping saw of claim 2, wherein the reciprocating mechanism is a slider and crank mechanism.

5. The powered coping saw of claim 2, wherein the reciprocating mechanism is a Scotch yoke mechanism.

6. The powered coping saw of claim 2, wherein the rotational motion comprises rotational motion around an axis that is perpendicular to an axis along which the saw blade travels during the reciprocating motion.

7. The powered coping saw of claim 2, wherein:
the rotational motion comprises rotational motion around an axis that is generally parallel to an axis along which the saw blade travels during the reciprocating motion; and
the actuator further comprises a bevel gear set configured to transfer the rotational motion to the reciprocating mechanism.

8. The powered coping saw of claim 1, wherein the actuator is a linear solenoid.

9. The powered coping saw of claim 1, wherein the spring-loaded clamp is connected to the frame via a linear bearing assembly.

10. The powered coping saw of claim 1, wherein the frame is a U-shaped frame, and the frame is attached to the handle via one arm of two substantially parallel arms of the frame.

11. The powered coping saw of claim 10, wherein:
the frame comprises an L-shaped fixed frame portion and a U-shaped linkage assembly;
the frame is attached to the handle via the L-shaped fixed frame portion; and
the U-shaped linkage assembly includes the two substantially parallel arms.

12. The powered coping saw of claim 11, wherein the U-shaped linkage assembly comprises a first pair of pivot points and a second pair of pivot points, is pivotably attached to the L-shaped fixed frame portion at the first pair of the pivot points and is pivotably attached to the saw blade at the second pair of the pivot points.

13. The powered coping saw of claim 12, wherein the two substantially parallel arms are configured to pivot about the first pair of pivot points.

14. The powered coping saw of claim 1, further comprising a stabilizing shoe attached to the handle.

15. A powered coping saw, comprising:
a handle;
a saw blade;
a linkage assembly attached to the handle and configured to support the saw blade between two substantially parallel arms of the linkage assembly, wherein the two substantially parallel arms are pivotably attached to a fixed frame portion of the linkage assembly at a first pair of pivot points; and
an actuator attached to the handle and configured to apply reciprocating motion to the saw blade.

16. The powered coping saw of claim 15, wherein:
the fixed frame portion is L-shaped;
a U-shaped linkage portion of the linkage assembly includes the two substantially parallel arms; and
the linkage assembly is attached to the handle via the fixed frame portion.

17. The powered coping saw of claim 15, wherein the linkage assembly is pivotably attached to the saw blade at a second pair of pivot points.

18. A powered coping saw, comprising:
a handle;
a saw blade;
a frame attached to the handle and configured to support the saw blade between two arms of the frame; and
a linear solenoid attached to the handle and configured to apply reciprocating motion to the saw blade.

19. The powered coping saw of claim 18 further comprising a variable speed trigger operably connected to the linear solenoid for controlling the reciprocating motion of the saw blade.

20. The powered coping saw of claim 18, further comprising a battery pack removably attached to a first end of the handle, wherein the linear solenoid is attached to a second end of the handle opposite the first end.
